(19) United States
(12) Patent Application Publication
(10) Pub. No.: US 2012/0022178 A1
(43) Pub. Date: Jan. 26, 2012

(54) METHODS OF EMBEDDING FOAM WITH ADDITIVES

(75) Inventors: Michael McCluskey, Auburn, ME (US); John Edward Condon, Sumner, ME (US); Glen Alan Bailey, Minot, ME (US)

(73) Assignee: DIVERSIFIED GLOGAL TECHNOLOGIES, LLC, Woonsocket, RI (US)

(21) Appl. No.: 13/162,272

(22) Filed: Jun. 16, 2011

Related U.S. Application Data
(60) Provisional application No. 61/355,881, filed on Jun. 17, 2010.

(51) Int. Cl. C08L 75/14; B05D 3/02; B05D 3/00; B05D 5/00; B05D 7/00; B05D 3/12

(52) U.S. Cl. 521/170; 427/355; 427/359

(57) ABSTRACT

The invention relates to a various methods of adding a liquid additive to a foam whereby the location of the additive within the foam can be precisely controlled. It also describes embodiments of a foam wherein the additive has been localized at particular areas of the foam.

### CROSS REFERENCE TO RELATED APPLICATIONS

This application claims priority to U.S. Provisional Patent Application No. 61/355,881 filed on Jun. 17, 2010 titled “Methods of Imbedding Foam with Liquid Additives”. The contents of the above-identified Application are relied upon and incorporated herein by reference in its entirety.

### FIELD OF INVENTION

The invention relates to a method of making a foam footbed with imbedded additives and to the foam footbed with embedded additives itself.

### BACKGROUND OF INVENTION

Foam footbeds have in the past been used to augment or impart additional functionality to footwear. For example, the specific conformational adjustments employed in the tailoring of orthotics to a specific user have been employed to increase the comfort of footwear for users who require support tailored to their specific foot. Additives, such as odor-reducers, have been utilized to impart advantageous functionality to footwear as well. These additives are usually incorporated to an aqueous mixture containing prepolymer and water, which under the right conditions undergo polymerization reactions to effectively suspend the additive in the footbed.

These prior art methods for incorporating functional additives into a foam construct are often assembly-line type processes on which the prepolymer aqueous mixtures are admixed with additive emulsions and the like to provide the polymeric foam/additive composition. However, these prior art methods of producing foam/additive constructs do not allow for selective application and specific control of additive application. The prior art admixing techniques often produce foam constructs with uniformly distributed additives. Thus, additives would need to be added in excess to ensure their functionality was imparted to the desired region of the foam footbed, and therefore a potentially substantial amount of additive is wasted by imparting their functionality to regions of a foam footbed where said functionality is unwanted or could go unused. For example, a prior art footbed wishing to provide a high surface concentration of additive would need to provide sufficient additive not only for the surface, but for the interior of the foam footbed as well, as there is no provision for localized additive control.

What is desired, therefore, is a method of making a foam with additives which are localized. It is further desired to precisely control the placement of these additives within the foam, such as by controlling the density of the additives in a specific region of the foam or limiting the placement of the additives to a precisely defined area of the foam. Finally, it is desired to provide a foam footbed by this method, wherein additives are incorporated in precisely controlled quantities and exhibit controlled release behavior.

### SUMMARY OF INVENTION

It is therefore an object of the invention to provide a method of making a foam footbed with additives, wherein the specific placement and concentration of the additives may be precisely controlled. It is also an object of this invention to provide a foam footbed with precisely controlled additive placement, and further to provide a footbed which exhibits controlled release behavior of these additives. In one embodiment, the instant invention provides for a method for embedding a foam with an additive, comprising the steps of providing a foam, contacting an additive with the foam, and pressing the additive against the foam for penetrating the additive into the foam. In another embodiment, the method further comprises the step of suspending the additive in a liquid. In a further embodiment, the method further comprises the step of reducing moisture in the foam for ease of handling, packaging, and subsequent use. In another embodiment, the method further comprises the step of pressuring the additive and foam together for penetrating the additive into the foam.

The method of the instant invention may, in a further embodiment, comprise the step of raising a temperature of the foam for facilitating penetration. In another embodiment, the method may comprise the step of pressing the additive using at least one roller. In one embodiment, the method may comprise the step of controlling a depth of penetration of the additive into the foam by varying a density of the foam, an amount of the additive, flow rate of a spray nozzle, position of the spray nozzle relative to the foam, position of at least one roller, a pressure exerted by at least one roller, a reflex of the foam, and combinations thereof. In other embodiments, the method of the instant invention may comprise the step of controlling a depth of penetration of the additive into the foam along a length of the foam. In one embodiment, the step of controlling a concentration of the additive along a length of the foam may be present. In a further embodiment, the step of controlling a release of the additive from the foam may be employed.

In one embodiment, the method of the instant invention further comprises the step of selecting an additive selected from the group consisting of: a skin conditioning agent, a vitamin, a soap, a gelling agent, an anti-infective agent, a keratolytically active agent, a vasoactive agent, a retinoid, anti-inflammatory agent, an anti-allergic agent, anti-wrinkle agent, a radical scavenger, a. self-tanning agent, a skin whitening agent, a skin protective agent, suntan lotion, an anti-cellulite agent, a massaging oil, an anti-wart agent, an antibiotic, an antibacterial agent, an anti-fungal agent, an antiviral agent, an anti-parasitic agent, an anesthetic, an analgesic, a corticosteroid, an anti-cancer agent, a photodynamic therapy agent, a lubricating agent, vitamin E, alpha hydroxyl acid, and combinations thereof.

In one embodiment, the instant invention comprises a method for embedding a foam with an additive, comprising the steps of providing a foam, contacting an additive with the foam, pressuring the additive and foam together for penetrating the additive into the foam, controlling a depth of penetration of the additive into the foam by varying a density of the foam, an amount of the additive, flow rate of a spray nozzle, position of the spray nozzle relative to the foam, position of at least one roller, a pressure exerted by at least one roller, a reflex of the foam, and combinations thereof, and varying a depth of penetration of the additive into the foam along a length of the foam. In another embodiment, the method further comprises the step of controlling a release of the additive from the foam. In an additional embodiment, the method may comprise the step of adding a superabsorbent polymer.

In one embodiment, the foam with an additive was produced by a reaction composition comprising approximately 0.05% to approximately 0.5% by weigh superabsorbent polymer, approximately 0.5% to approximately 15% by weight additive, and approximately 15% to about 85% by weight water.

Another embodiment of the instant invention comprises a foam with an additive, the foam comprising a foam, a plurality of additives dispersed within the foam, a depth of penetration of a first additive in a selected first location, a depth of penetration of a second additive in a second location selected to be different than the depth of the penetration of the first additive, a density of the foam in a selected first location, and a density of the foam in a second location selected to be different than the density in the first location. In an additional embodiment, the foam with an additive additionally comprises a superabsorbent polymer selected from the group consisting of polyacrylate/polyalcohol polymers and co-polymers and combinations thereof.

In one embodiment, the foam with an additive is formed by a reaction composition comprising approximately 0.05% to approximately 0.5% by weigh superabsorbent polymer and approximately 0.5% to approximately 40% by weight additive. In an additional embodiment, the reaction composition of the foam with an additive comprises approximately 0.5% to approximately 15% by weight additive.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may be understood by reference to the detailed description which follows taken in conjunction with the accompanying drawings in which:

FIG. 1 depicts one embodiment of a method for making a foam with imbedded additives.

FIG. 2 depicts another embodiment of the method of FIG. 1.

FIG. 3 depicts another embodiment of the method of FIG. 1.

FIG. 4 depicts an embodiment of an exemplary apparatus for performing the method of FIG. 1.

FIG. 5 depicts the chemical structure of Vitamin E (α-tocopherol).

### DETAILED DESCRIPTION

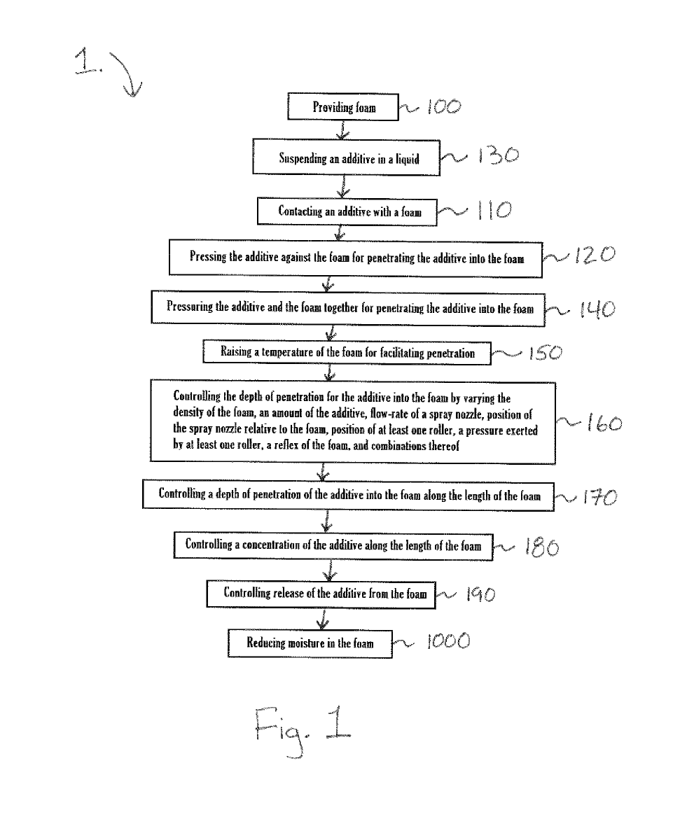

In describing the following embodiments of the present invention, reference will be made herein to FIGS. 1-4 of the drawings in which like numbers refer to like features of the invention.

Before the present embodiments are described, it is to be understood that this invention is not limited to the particular processes, compositions, or methodologies described, as these may vary. It is also to be understood that the terminology used in the description is for the purpose of describing the particular versions or embodiments, and is not intended to limit the scope of the present inventions. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

It must also be noted that as used herein and in the appended claims, the singular forms “a”, “an”, and “the” include plural reference unless the context clearly dictates otherwise. Thus, for example, reference to an “adjustable roller” is a reference to one or more adjustable rollers and equivalents thereof known to those skilled in the art, and so forth.

As used herein, the term “comprises” means includes at least the following but does not exclude others.

The term “improve” is used to convey that the embodiments change either the appearance, form, characteristics and/or the physical attributes of the tissue to which it is being provided, applied or administered. The change in form may be demonstrated by any of the following, without limitations, alone or in combination: enhanced appearance of the skin; increased softness of the skin; increased turgor of the skin; increased texture of the skin; increased elasticity of the skin; decreased wrinkle formation and increased endogenous elastin production in the skin, increased firmness and resiliency of the skin.

Unless otherwise indicated, the term “skin” means that outer integument or covering of the body, consisting of the dermis and the epidermis and resting upon subcutaneous tissue.

As used herein, the term “body” or “subject” refers to any animal, preferably a mammal. The term “mammal” as used herein, encompasses any mammal. Examples of mammals include, but are not limited to, humans, cows, horses, sheep, pigs, cats, dogs., mice, rats, rabbits, guinea pigs, monkeys, etc.

The term “skin sensitizer” means a substance that will induce an allergic response following skin contact.

As used herein, the term “therapeutic” means an agent utilized to ameliorate, prevent or improve an unwanted condition or disease of a patient. In part, some embodiments are directed to the treatment of skin conditions.

An “effective amount” of an additive is a predetermined amount calculated to achieve the desired effect, i.e., to treat, improve, diminish or reverse the activation, migration, or proliferation of cells.

The terms “treat,” “treated,” or “treating” as used herein refer to therapeutic or cosmetic treatment and prophylactic or preventative measures, wherein the object is to prevent or slow down (lessen) an undesired physiological condition, disorder or disease, or to obtain beneficial or desired clinical results. Beneficial or desired clinical results include, but are not limited to, alleviation of symptoms, diminishment of the extent of the condition, disorder or disease; stabilization (i.e., not worsening) of the state of the condition, disorder or disease: delay in onset or slowing of the progression of the condition, disorder or disease; amelioration of the condition, disorder or disease state: and remission (whether partial or total), whether detectable or undetectable, or enhancement or improvement of the condition, disorder or disease. Treatment includes eliciting a clinically significant response without excessive levels of side effects.

One embodiment of the instant invention is a method 1, shown in FIG. 1, comprising the step of providing 100 a foam through any suitable prior art method, exemplary embodiments of which are described below and are later incorporated herein by reference. The foam is provided with a density. The density of the foam may be constant throughout the foam construct or may, in one embodiment, vary by location in the foam. For example, the foam may be more dense at the heel of a foam footbed than the rest of the footbed. The method further comprises a step of contacting 110 an additive with the foam. In one embodiment, that additive is a solid which has already been suspended 130 in a liquid. Further embodiments relating to the composition and addition of additives to the foam are described in greater detail below. The method then comprises pressing (i.e. being brought into contact) 120 and pressuring (i.e. forcibly held together for any length of time) 140 the additive against the foam for penetrating the additive into said foam. In one embodiment, the method comprises raising 150 a temperature of the foam for facilitating penetration of the additive, a step which will be described in greater detail below. In a further embodiment, the method comprises a step of controlling 160 a depth of penetration of the additive into the foam by varying the density of the foam, an amount of the additive, flow-rate of a spray nozzle, position of the spray nozzle relative to the foam, position of at least one roller, a pressure exerted by at least one roller, a reflex of the foam, and combinations thereof. In a further embodiment, the method comprises a step of controlling 170 a depth of penetration of the additive into the foam along the length of the foam. Another embodiment comprises the step of controlling 180 a concentration of the additive along the length of the foam. Further, the method may comprise the step of controlling 190 release of the additive from the foam. Finally, the method may comprise the step of reducing 1000 moisture in the foam. All of the above method steps are explained in greater detail below.

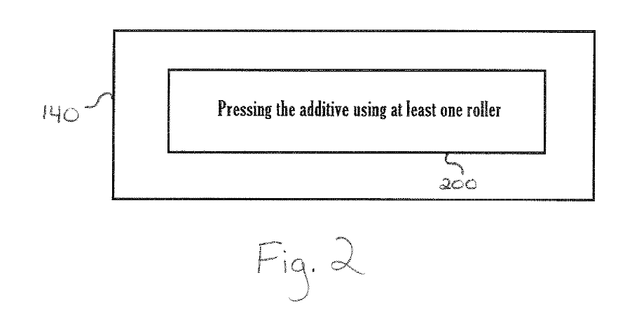

Referring now to FIG. 2, the method step of pressuring (i.e. forcibly held together for any defined length of time) 140 the additive against the foam for penetrating the additive into said foam may further comprise the step of pressing 200 the additive using at least one roller.

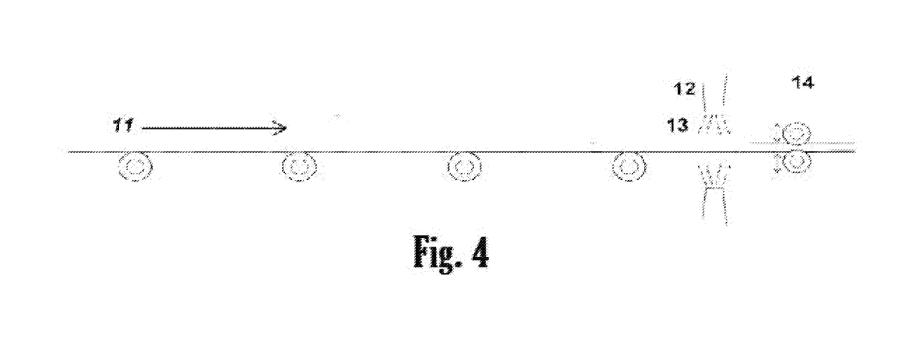

In one embodiment, and referring to FIG. 4, the method of embedding a foam with one or more additives comprises obtaining a foam that is manufactured by any known or hereafter known process, 11, adding an additive sample 13 to the foam via a spray nozzle 12, and applying pressure to the foam, such as by squeezing the foam using an adjustable roller 14, to penetrate the additive into the foam. In certain embodiments, the foam comprises a cosmetic foam manufactured by any known or hereafter known process including, but not limited to, methods described the following patent documents, incorporated herein by reference: U.S. Pat. No. 3,294,879: U.S. Pat. No. 3,573,234; U.S. Pat. No. 3,586,648: U.S. Pat. No. 4,714,574; U.S. Patent Publication No. 2006/0140984; and U.S. Patent Publication No. 2008/0063607. The exact amount of pressure exerted to the foam is determined by composition of the foam itself, but the pressure exerted should be sufficient to incorporate all of the additive sample into the foam and still enable the foam to retain approximately 10% to approximately 25% of the its original thickness. In some embodiments, the foam begins as a reaction composition comprising components such as prepolymer, water, and an additive, though other components may be added without limitation. The reaction composition may be an aqueous mixture with water comprising approximately 15% to approximately 85% by weight of the aqueous mixture. Use of less water in the reaction composition may make handling and dispensing of the aqueous mixture more difficult than necessary, plus it may lead to an under polymerized construct, while higher amounts of water may make the aqueous mixture difficult to physically control or shape.

It is by controlling the flow-rate of the additive sample 13 out of spray nozzle 12 that the additive may be selectively applied to a first, second, or any number location on the foam construct, and it is through applied pressure from at least one roller 14 to a foam of a specific density that the depth to which the additive sample penetrates the foam construct can be controlled as well. In certain embodiments, pressure is applied to the foam through a plurality or series of adjustable rollers 14, such as the pair of rollers portrayed in FIG. 4. Said pair of rollers may be squeezed together as the foam passes between them. In certain embodiments, the adjustable rollers include a set of nip rollers. A plurality of rollers provided in series may be advantageous as they would allow for multiple, distinct additive application steps. In this embodiment, two or more additives may be applied by the method of the instant invention without the need to produce one homogenous additive mixture that must necessarily be applied to the foam all at once. Alternatively, the fluid may be drawn into the foam by subjecting foam to which liquid has been applied to a pressure such as may occur in a pressure chamber, a vacuum chamber, a force-applying mechanism, or even by allowing gravity to pull liquid downward into the foam.

In certain embodiments, the method may further comprise controlling the depth and amount of penetration of the additive into the foam. In one embodiment, controlling the depth and amount of penetration may comprise varying any of the following: a density of the foam, an amount of the additive, flow rate of the spray nozzle, position of the nozzle in relation to the foam, position of the adjustable rollers, a pressure exerted by the adjustable roller, a reflex of the foam, run speed of the conveyor belt or mixtures thereof. Controlling the density of the foam would allow a user to control not only the amount of additive than can be applied to the foam before it becomes saturated, but also control the depth to and rate at which additives and moisture may permeate. Control of the density of the foam along with control of the concentration of the additive sample which is applied to said foam can allow a user to tailor the fabrication method to their needs. For example, a user could produce highly saturated foams with low concentrations of additive, wherein the additive is generally evenly distributed throughout the whole foam, or they may produce highly concentrated foams where the additive can only permeate a few microns into the interior, but be of a generally high concentration so as to deliver high doses of additive upon contact of the foam with any other surface.

By controlling the flow rate and position of the nozzle delivering the additive to the foam, the additive may be delivered locally at varying concentrations. For instance, in a foam where one half of the construct requires a high concentration of additive and the other half of the construct requires a low concentration of additive, the nozzle may be initially directed towards one half of the foam only and deliver a high flow-rate spray of additive. The spray nozzle may subsequently redirect the spray towards the other half of the foam and reduce the flow-rate to a mere percentage of the first flow-rate, thus delivering a smaller amount of additive providing localized concentrations of the additive.

In the case of the pressure exerted to the foam and the reflex of the foam itself, it can be understood that exerting more pressure on the foam could cause greater and deeper uptake of additive into the foam. The same behavior follows for foams with higher reflex. The word “reflex” herein refers to a foam construct's ability to recover from an applied deformative force, such as pressure from the rollers 14 in FIG. 4. For instance, a foam construct with a high reflex will substantially return to the same conformation after removal of an applied deformative force. In recovering its former conformation, the foam itself creates a vacuum within the open cells of its interior, the force of which can force transport of an additive disposed on the surface of the foam construct to the interior of the foam construct. If the same compressive force is applied to two foams with different reflex abilities, the foam with the higher reflex will absorb more additive as the vacuum created by the higher reflex foam construct will be more substantial. A user is then capable of determining the precise amount of compression necessary given a foam's reflex to provide the foam with a certain additive amount to a certain penetration depth.

The run speed of the conveyor (or the foam itself) can be adjusted to produce a similar effect as the change in flow-rate described above. With flow-rates on an assembly line kept constant, the speed of the foam through the spray will govern the amount of additive applied to the foam. In one embodiment, combinations of conveyors may be used to slowly bring a foam through a spray of a certain additive in which a higher concentration of that additive is desired, while another conveyor (or the same conveyor capable of having its speed modulated) may be used to quickly bring a foam through a spray of another or even the same additive. In an exemplary embodiment, a user may desire to have a foam footbed with a high concentration of an additive on the bottom with a small concentration of the additive on the top. The foam may be slowly conveyed under a nozzle with a constant flow-rate of additive, which coats one side said of the footbed with a large amount of additive. The footbed would then be compressed and released to incorporate the high concentration of additive into that side of the footbed. The same conveyor may then bring the same footbed along at faster speed to coat the other side of the foam, this time with a smaller amount of additive which upon compression and subsequent release will become incorporated on the other side of the foam, thereby producing a foam with clearly defined, stratified layers of additive.

These variables may be programmed into a software program and controlled through a general purpose computer. In certain embodiments, the additive may be imbedded into certain localized areas of the foam. In certain embodiments, the additive may be imbedded within various depths of the foam. The additive may be imbedded in certain localized areas or various depths of the foam by, for example, without limits, turning the spray nozzle on and off at controlled intervals, adjusting the flow rate of the spray, controlling when pressure is applied by the adjustable rollers, the amount of pressure applied by the adjustable rollers, or any combination thereof.

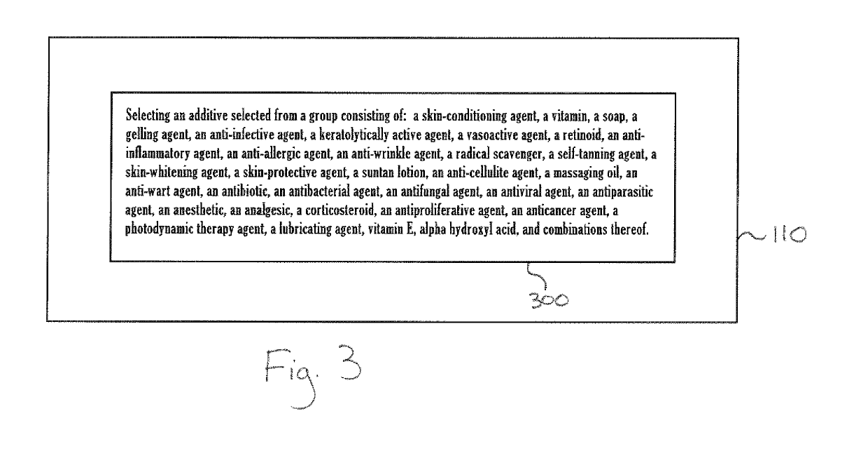

In certain embodiments, adding the additive to the foam may comprise spraying, dipping, or using a transfer roll. In certain embodiments, the foam may comprise an open cell foam, including, but not limited to, polyurethane foam, polyethylene foam, polystyrene foam, or expanded polystyrene (EPS) foam. In one embodiment, the foam may comprise polyurethane foam. In certain embodiments, the foam may be hydrophilic. Referring now to FIG. 3, the method step of contacting 110 an additive with a foam further comprises the step of selecting 300, in certain embodiments, the additive from a group consisting of: a skin conditioning agent, a vitamin, a soap, a suntan lotion, a gelling agent, an anti-infective agent, a keratolytically active agent, a vasoactive agent, a retinoid, an anti-inflammatory agent, an anti-allergy agent, an anti-wrinkle agent, a radical scavenger, a self-tanning agent, a skin-whitening agent, a skin-protective agent, an anti-cellulite agent, a massaging oil, an anti-wart agent, an antibiotic, an antibacterial agent, an antifungal agent, an antiviral agent, an anti-parasitic agent, an anesthetic, an analgesic, a corticosteroid, an anti-cancer agent (such as a chemotherapeutic drug), a photodynamic therapy agent (such as aminolevulinic acid or the like), a lubricating agent, any other liquid agent or mixtures thereof. In certain embodiments, the additive may comprise alpha hydroxy acid (AHA). In certain embodiments, the additive may comprise vitamin E. Any of these additives may be provided, in one embodiment, at concentrations of approximately 0.5% to 40% by weight additive in the reaction composition. Concentrations below this range are likely to yield little noticeable functionality, while concentrations higher than this range are likely to produce a diminishing return, as the cost of providing more additive fails to produce substantial returns in functionality. In an additional embodiment, the concentration of the additive in the reaction composition is between approximately 0.5% and approximately 15%.

In certain embodiments, the foam may be odorless, hypoallergenic, a bright white standard color, capable of being tinted, capable of being rinsed and reused or any combination thereof. The additive of the instant invention may be provided to the foam in any suitable form or phase. For example, the additive may be in a liquid form of a suitable viscosity for application to a foam by itself or for incorporation into a reaction composition for the foam. In another embodiment, the additive may be a solid which may be applied to the foam at any point during its fabrication, such as to the reaction composition, during polymerization, or to the finished footbed itself. Finally, the additive may be a solid suspended in an aqueous mixture and admixed with a reaction composition, the polymerizing foam, or the polymerized finished product. The determination of what phase an additive should be applied is well within the abilities of one of ordinary skill in the art and dependent on the specific additive to be applied. Further embodiments regarding the use of additives in the instant invention are described in the following patent documents, incorporated herein by reference: U.S. Pat. No. 5,976,616 and U.S. Pat. No. 6,566,576.

In a particular embodiment, referring again to FIG. 4, an open cell hydrophilic foam may be placed on a conveyor belt 11 and as the foam passes through the spray nozzles 12, it may be coated with a liquid additive 13. The foam may then be squeezed by adjustable rollers 14 to imbed the additive at least partially into the pores of the foam. Without intending to be bound by theory, when the foam rebounds after being squeezed by the adjustable rollers 14 to come back to its original shape, the reflex action draws the additive into the foam. In one embodiment, uptake of the additive into the foam may be aided by a general increase in temperature of the foam, additive, and/or the foam and additive's surroundings. The increase in temperature should facilitate uptake of the additive by causing the foam network to expand, allowing for more space for an additive to diffuse into the foam, and in the case of a liquid additive or additive suspension, reducing the viscosity of the additive to more easily diffuse into the foam. The specific temperatures used in this process are governed by the specific polymer and additives being used, as the tolerances may vary greatly from one polymer or additive to another. For instance, should the additive be a protein sample with a denaturation temperature of approximately 50 degree Celsius, the temperature at which the additive uptake is performed may be significantly lower than if the additive were an elemental silver solution which may tolerate much higher temperatures. Temperature determinations for the temperature raising step are well within the abilities of one of ordinary skill in the art. Embodiments of the present method may partially or completely saturate the foam with the additive. In certain embodiments, the additives may be released from the foam when used by a consumer in a dry form. In other embodiments, the additives may be released from the foam when the foam is wet. In one embodiment of the instant method, imparting controlled release functionality of the additive is contemplated. This may be accomplished by the addition of superabsorbent polymers, which will be discussed below.

In some embodiments, the foam may be used for a one-time application. In such embodiments, the additive may be released from the foam at one time. In other embodiments, the foam may be reused to slowly release the additive over time.

In some embodiments, the additive may be added to the foam at any time after manufacturing the foam. For example, the additive may be added in line with the manufacturing process, after the foam is cured but before the foam is dried to remove residual moisture or after the foam is dried to remove residual moisture, or several days, months or years after the foam has been manufactured. In a particular embodiment, the liquid additive is added immediately after the foam manufacturing process to avoid double handling and double drying costs. In certain embodiments, the method may further comprise drying the foam to eliminate any residual moisture for ease of use, handling, and the like. In certain embodiments, drying the foam comprises air drying or using a radio frequency dryer, infrared dryer, hot air dryer, infra air dryer, a convection dryer, microwave dryer, or combinations thereof.

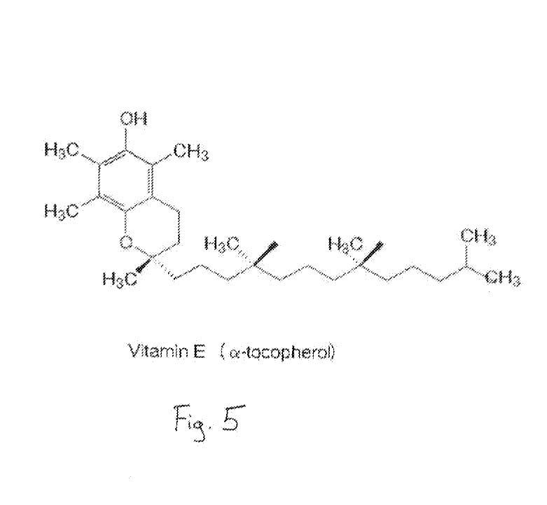

In certain embodiments, the additive comprises vitamin E. The term “vitamin E” encompasses all members of the vitamin E family including, but not limited to, the tocopherol structure shown in FIG. 5, tocotrienol structure and any derivatives thereof. Both structures are similar except the tocotrienol structure contains double bonds on the isoprenoid units. Many derivatives of these structures are possible due to the addition of different substituents on the aromatic ring at positions 5, 6, 7, and 8.

Without wishing to be bound by theory, an exemplary benefit of a polyurethane foam containing vitamin E made according to embodiments of the method described herein is that such foam may be less toxic and may provide more vitamin E per unit volume in the foam when compared to methods of embedding an additive in a polyurethane foam described in prior art, in which, for example, the vitamin E is added with the aqueous starting elements of the foam manufacturing process. Particularly, the vitamin E compound contains a hydroxyl (OH) group (see FIG. 2). If the vitamin E is added with the aqueous starting elements of the polyurethane foam manufacturing process, the vitamin E may be consumed before it is imbedded into the foam through a reaction between the free hydroxyl group on the vitamin E and the urethane molecule while the urethane is polymerizing. The reaction between the vitamin E with the urethane molecule may render the foam inactive and a skin sensitizer. In contrast in embodiments of the method described herein, the vitamin E would not react with the urethane molecules because the vitamin E is being added after substantial polymerization or complete polymerization of the polyurethane; thus the methods described herein may leave more unreacted vitamin E in the foam, such that more vitamin E can be released from the foam.

In an additional embodiment, the foam/additive construct further comprises a superabsorbent polymer, such as polyacrylate/polyalcohol polymers and co-polymers and combinations thereof. Said superabsorbent polymers could allow to controlled release of additives incorporated into the foam footbed. Controlled release behavior may include leaching of additives out of the footbed, whether that be through active or passive diffusion. The controlled release of the additive may be for the benefit of the user directly, such as bring an additive into contact with the user's foot in the case of a skin care agent, or indirectly, such as through release of an odor-reducing agent that may remove bacteria or moisture from the surrounding environment of the shoe outsole. In one embodiment, the concentration of the superabsorbent polymer is approximately 0.005% to approximately 10% by weight of the reaction composition. Concentrations lower than this range will likely provide little benefit to the finished product, while concentrations greater than this range will needlessly inhibit the amount of additive that may be provided in each footbed. In another embodiment, the concentration of the superabsorbent polymer is approximately 0.05% to approximately 5% by weight of the reaction composition.

This invention and embodiments illustrating the method and materials used may be further understood by reference to the following non-limiting examples.

### Example 1

A conveyor belt will transport a hydrophilic polyurethane foam through spray nozzles. The spray nozzles will spray an additive, vitamin E, onto the foam. The conveyor belt will then transport the foam through a series of nip rollers which will squeeze the foam to imbed the vitamin E partially within the foam. The foam may be air-dried to remove residual moisture and then may be dried again in a radio frequency (RF) dryer.

### Example 2

A conveyor belt will transport a hydrophilic polyurethane foam through spray nozzles. The spray nozzles will spray an additive, vitamin E. onto the foam. The conveyor belt will then transport the foam through a set of nip rollers which will squeeze the foam to imbed the vitamin E within the foam. The foam will then be dried in a radio frequency (RF) dryer.

### Example 3

A hydrophilic polyurethane foam will be sprayed with a liquid additive, alpha hydroxy acid. A conveyor belt will then transport the foam through a series of nip rollers which will squeeze the foam to imbed the alpha hydroxy acid within the foam. The foam will then be dried in a radio frequency (RF) dryer.

### Example 4

One or more alpha hydroxy acids (AHAs) will be sprayed onto a hydrophilic polyurethane foam. Nip rollers will then squeeze the foam to imbed the AHAs within the foam, optionally leaving some AHA on the surface of the foam. Optionally, the foam will then be cut and/or then laminated to another material, such as an exfoliating pad. The foam will then be die cut into various shapes for use in the cosmetic industry. When a customer uses the foam, a small amount of water will be added to the hydrophilic side to activate the AHAs. When a customer wipes the skin, the AHAs will be released to contact the skin.

Although the present invention has been described in considerable detail with reference to certain preferred embodiments thereof, other versions are possible. Therefore the spirit and scope of the invention should not be limited to the description and the preferred versions contained within this specification.

What is claimed is:

1. A method for embedding a foam with an additive, comprising the steps of providing a foam; contacting an additive with the foam; pressing the additive against the foam for penetrating the additive into the foam.

2. The method according to claim 1, further comprising the step of suspending the additive in a liquid.

3. The method according to claim 1, further comprising the step of reducing moisture in the foam for ease of handling, packaging, and subsequent use.

4. The method according to claim 1, further comprising the step of pressuring the additive and foam together for penetrating the additive into the foam.

5. The method according to claim 4, further comprising the step of raising a temperature of the foam for facilitating penetration.

6. The method according to claim 4, further comprising the step of pressing the additive using at least one roller.

7. The method according to claim 1, further comprising the step of controlling a depth of penetration of the additive into the foam by varying a density of the foam, an amount of the additive, flow rate of a spray nozzle, position of the spray nozzle relative to the foam, position of at least one roller, a pressure exerted by at least one roller, a reflex of the foam, and combinations thereof.

8. The method according to claim 1, further comprising the step of controlling a depth of penetration of the additive into the foam along a length of the foam.

9. The method according to claim 1, further comprising the step of controlling a concentration of the additive along a length of the foam.

10. The method according to claim 1, further comprising the step of controlling a release of the additive from the foam.

11. The method according to claim 1, further comprising the step of selecting an additive selected from the group consisting of: a skin conditioning agent, a vitamin, a soap, a gelling agent, an anti-infective agent, a keratolytically active agent, a vasoactive agent, a retinoid, anti-inflammatory agent, an anti-allergic agent, anti-wrinkle agent, a radical scavenger, a. self-tanning agent, a skin whitening agent, a skin protective agent, suntan lotion, an anti-cellulite agent, a massaging oil, an anti-wart agent, an antibiotic, an antibacterial agent, an anti-fungal agent, an antiviral agent, an anti-parasitic agent, an anesthetic, an analgesic, a corticosteroid, an anti-cancer agent, a photodynamic therapy agent, a lubricating agent, vitamin E, alpha hydroxyl acid, and combinations thereof.

12. A method for embedding a foam with an additive, comprising the steps of:
providing a foam;
contacting an additive with the foam; pressuring the additive and foam together for penetrating the additive into the foam;
controlling a depth of penetration of the additive into the foam by varying a density of the foam, an amount of the additive, flow rate of a spray nozzle, position of the spray nozzle relative to the foam, position of at least one roller, a pressure exerted by at least one roller, a reflex of the foam, and combinations thereof;
varying a depth of penetration of the additive into the foam along a length of the foam.

13. The method according to claim 12, further comprising the step of controlling a release of the additive from the foam.

14. The method according to claim 13, further comprising the step of adding a superabsorbent polymer.

15. The method of claim 14, wherein the foam with an additive was produced by a reaction composition comprising approximately 0.05% to approximately 0.5% by weigh superabsorbent polymer, approximately 0.5% to approximately 15% by weight additive, and approximately 15% to about 85% by weight water.

16. A foam with an additive, comprising:
a foam
a plurality of additives dispersed within the foam;
a depth of penetration of a first additive in a selected first location;
a depth of penetration of a second additive in a second location selected to be different than the depth of the penetration of the first additive;
a density of the foam in a selected first location; and
a density of the foam in a second location selected to be different than the density in the first location.

17. The foam with an additive of claim 16, additionally comprising a superabsorbent polymer selected from the group consisting of: polyacrylate/polyalcohol polymers and co-polymers and combinations thereof.

18. The foam with an additive of claim 17, wherein the foam with an additive is formed by a reaction composition comprising approximately 0.05% to approximately 0.5% by weigh superabsorbent polymer and approximately 0.5% to approximately 40% by weight additive.

19. The foam with an additive of claim 18, wherein the reaction composition comprises approximately 0.5% to approximately 15% by weight additive.
